(19) United States
(12) Patent Application Publication
(10) Pub. No.: US 2016/0354763 A1
(43) Pub. Date: Dec. 8, 2016

(54) HYDROCARBON REFORMER INCLUDING A CORE-SHELL CATALYST

(71) Applicant: DOOSAN FUEL CELL AMERICA, INC., South Windsor, CT (US)

(72) Inventor: Minhua SHAO, Farmington, CT (US)

(21) Appl. No.: 15/238,994

(22) Filed: Aug. 17, 2016

Related U.S. Application Data
(62) Division of application No. 14/124,163, filed on Dec. 5, 2013.

(51) Int. Cl. B01J 23/755; C01B 3/40; B01J 37/16; B01J 35/02; B01J 37/02; B01J 8/22; B01J 23/46

(52) U.S. Cl. CPC B01J 23/755; B01J 8/22; C01B 3/40; B01J 23/464; B01J 35/026; B01J 37/0221; B01J 37/0225; B01J 37/16; C01B 2203/0233; C01B 2203/1058; C01B 2203/1064; C01B 2203/1241

(57) ABSTRACT

An illustrative example embodiment of a hydrocarbon reformer includes a vessel with at least one inlet and at least one outlet. A reforming catalyst is in the vessel includes a metal core and a rhodium layer deposited on the metal core. Hydrogen is generated when hydrocarbon introduced through the inlet reacts with water in the presence of the reforming catalyst. The hydrogen is released from the vessel through the at least one outlet.

### CROSS REFERENCE TO RELATED APPLICATIONS

This application is a divisional of U.S. application Ser. No. 14/124,163, which was filed on Dec. 5, 2013, which is the U.S. national phase application of PCT Application PCT/US2011/035862, which was filed on May 10, 2011.

### BACKGROUND

Fuel cells are electrochemical cells that convert chemical energy into electric energy. One example of a fuel cell includes an anode, a cathode and an electrolyte between the anode and cathode. Electricity is generated from the reaction between a fuel supply and an oxidant. Many combinations of fuels and oxidants are possible. In one example, hydrogen gas is fed to the anode and air or pure oxygen is fed to the cathode. At the anode, an anode catalyst causes the hydrogen molecules to split into protons (H⁺) and electrons (e⁻). The protons pass through the electrolyte to the cathode while the electrons travel through an external circuit to the cathode, resulting in production of electricity. At the cathode, a cathode catalyst causes the oxygen molecules to react with the protons and electrons from the anode to form water, which is removed from the system. For example, in hydrogen-oxygen fuel cells, hydrogen is the fuel while oxygen is the oxidant. Often, the hydrogen used in these fuel cells is derived from hydrocarbons.

Hydrocarbons can be reacted in a fuel reformer to produce hydrogen. Steam reforming of natural gas (steam methane reforming, or SMR) is one common method of reforming hydrogen. Natural gas contains high concentrations of methane, as well as lower concentrations of higher hydrocarbons (primarily ethane). At high temperatures and in the presence of a reforming catalyst, steam reacts with methane to produce carbon monoxide (CO) and hydrogen according to the following reaction:

CH₄+H₂O→CO+3H₂

Additional hydrogen can be produced by a gas-shift reaction with the CO produced by the reaction above. This second reaction proceeds according to the following:

CO+H₂O→CO₂+H₂

In addition to methane and other hydrocarbons, natural gas also contains nitrogen. Nitrogen can react with the hydrogen generated during reforming to form ammonia (NH₄) in the presence of some reforming catalysts such as nickel catalysts. Unfortunately, ammonia poisons the anode of hydrogen fuel cells. As a result, fuel cell performance is reduced when hydrogen streams containing ammonia are used as fuel for the cell. The present invention provides a reforming catalyst that reduces the potential for ammonia formation during hydrogen reforming.

### SUMMARY

An illustrative example embodiment of a hydrocarbon reformer includes a vessel with at least one inlet and at least one outlet. A reforming catalyst is in the vessel includes a metal core and a rhodium layer deposited on the metal core. Hydrogen is generated when hydrocarbon introduced through the inlet reacts with water in the presence of the reforming catalyst. The hydrogen is released from the vessel through the at least one outlet.

An illustrative method of producing hydrogen within a hydrocarbon reformer includes introducing a hydrocarbon into a reformer and reacting the hydrocarbon with an aqueous solvent in the presence of a reforming catalyst in the reformer. The reforming catalyst includes a metal core and a rhodium layer deposited on the metal core.

Various features and advantages of at least one disclosed embodiment will become apparent to those skilled in the art from the following detailed description. The drawings that accompany the detailed description can be briefly described as follows.

### BRIEF DESCRIPTION OF THE DRAWINGS

FIG. 1 is a cross-sectional view of a core-shell catalyst for natural gas reforming.

FIG. 2 is a simplified schematic of a natural gas reformer.

FIG. 3 is a simplified schematic of a method for preparing a natural gas reforming catalyst.

### DETAILED DESCRIPTION

A natural gas reforming catalyst that reduces the potential for ammonia formation is described herein. The reforming catalyst is a core-shell catalyst having a metal core and a rhodium layer surrounding the metal core. The rhodium layer prevents ammonia formation by providing a catalytic pathway for hydrogen generation that has a reduced potential for ammonia production.

Fossil fuel reforming is a method of producing hydrogen from hydrocarbon-containing materials such as natural gas. In one example, the hydrocarbon-containing material is natural gas, which is composed of primarily methane. The natural gas reacts with steam at high temperature in a reformer during steam methane reforming (SMR). The reformer can operate as an individual unit or as a component in a larger system with other components such as fuel cells.

Steam reacts with methane at high temperatures (about 700° C. to about 1100° C.) in the presence of a metal-based catalyst to produce carbon monoxide and hydrogen according to the following equation.

CH₄+H₂O→CO+3H₂ (1)

The catalysts used in SMR reactions are typically nickel or palladium. These catalysts are necessary for the production of hydrogen according to the above equation. Additional hydrogen can be recovered by a gas-shift reaction according to the following equation.

CO+H₂O→CO₂+H₂ (2)

The nickel and palladium catalysts used in SMR reactions present one drawback. While these catalysts provide a cost-effective method for generating hydrogen from natural gas, they also facilitate reactions between nitrogen (N₂) in the natural gas and the generated hydrogen. Nickel and palladium catalysts allow nitrogen to react with hydrogen to form ammonia (NH₄) according to the following equation.

N₂+4H₂→2NH₄ (3)

Not only does ammonia formation reduce the available hydrogen for use as fuel, ammonia also poisons the anode of hydrogen fuel cells. Ammonia present in the fuel stream can adsorb on the catalyst surface at the fuel cell anode, reducing fuel cell performance and eventually rendering the fuel cell inoperable.

Like nickel and palladium, rhodium is a metal capable of catalyzing Reaction 1 shown above in which methane and water are converted to hydrogen and carbon monoxide. Unlike, nickel and palladium, however, applicants discovered that rhodium is a less effective catalyst for Reaction 3 shown above in which nitrogen and hydrogen react to form ammonia. Thus, rhodium catalysts can be used to produce hydrogen in SMR reactions while reducing the potential for ammonia generation at the same time. Unfortunately, rhodium is a more expensive material than nickel or palladium and their alloys. Therefore, a purely rhodium reforming catalyst is cost prohibitive. To reduce the potential of ammonia formation during SMR, a core-shell catalyst having a metal core and a rhodium shell surrounding the metal core is used in place of the typical nickel or palladium catalyst. This core-shell catalyst provides the advantages of a rhodium catalyst without the additional expense of a pure rhodium catalyst.

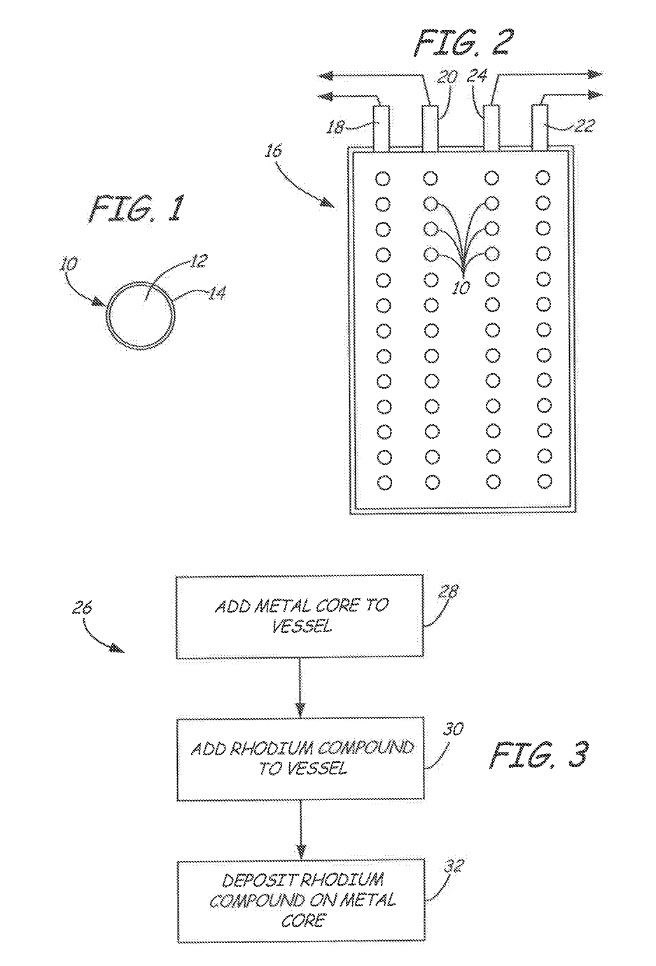

FIG. 1 illustrates a cross-sectional view of core-shell reforming catalyst 10. Core-shell reforming catalysts 10 are formed of metal core 12 and rhodium shell 14. Metal core 12 is formed from a metal capable of producing hydrogen according to Reaction 1 shown above. Metals suitable for use in metal core 12 include nickel, nickel alloys, palladium, palladium alloys and combinations thereof. Metal core 12 can vary in size. Metal core 12 can range in size from a nanoparticle to a thin film. Rhodium shell 14 surrounds or encapsulates metal core 12.

The amount of rhodium present in core-shell reforming catalyst 10 may be adjusted based on characteristics of core-shell reforming catalyst 10 including, but not limited to, the amount of nickel present in metal core 12, the particle size of the nickel in metal core 12 and the thickness of rhodium shell 14.

Rhodium shell 14 is a thin layer of rhodium or rhodium alloy atoms covering the outer surface of metal core 12. Rhodium shell 14 can be a monolayer, bilayer or trilayer or a submonolayer of rhodium or rhodium alloy atoms. Suitable rhodium alloys include alloys of platinum, palladium and iridium. Although core-shell reforming catalyst 10 is shown as being generally spherical in FIG. 1, core-shell reforming catalyst 10 can have any known shape. For example, core-shell reforming catalyst 10 can have cubic, octahedral or cubo-octahedral shapes.

In one embodiment, rhodium shell 14 is a monolayer surrounding metal core 12. That is, rhodium shell 14 forms a single layer of rhodium or rhodium alloy atoms around the external surface of metal core 12. Where rhodium shell 14 is a monolayer, rhodium shell 14 is generally an atomically thin layer, typically having a thickness of about 0.25 nanometers.

In another embodiment, rhodium shell 14 contains multiple layers of rhodium or rhodium alloy atoms surrounding metal core 12. In examples where rhodium shell 14 contains multiple layers of rhodium or rhodium alloy atoms. Where rhodium shell 14 contains multiple layers of rhodium or rhodium alloy atoms, rhodium shell 14 typically has a thickness between about 0.5 nanometers and about 3 nanometers. A multilayer rhodium shell 14 may provide increased durability and potentially reduce the potential for ammonia formation according to Reaction 3 above.

In another embodiment, rhodium shell 14 is a submonolayer partially surrounding metal core 12. A submonolayer is a partial layer rather than a fully complete monolayer. While a monolayer provides a complete single layer of rhodium or rhodium alloy atoms around metal core 12, a submonolayer provides incomplete coverage of metal core 12. When rhodium shell 14 of core-shell reforming catalyst 10 is a submonolayer, portions of metal core 12 are exposed. When rhodium shell 14 is a submonolayer, the rhodium or rhodium alloy atoms of rhodium shell 14 can cover or encapsulate substantially the entire outer surface of metal core 12 or only a small portion of metal core 12.

Rhodium shell 14 covers or encapsulates between about 10% and about 100% of the surface area of metal core 12. The degree to which metal core 12 is covered or encapsulated by rhodium shell 14 can depend on the fuel cell using the hydrogen generated by core-shell reforming catalyst 10. For example, for a fuel cell that is sensitive to even small amounts of ammonia, rhodium shell 14 will cover a substantial portion of the surface of metal core 12—up to about 100%. Here, rhodium shell 14 greatly reduces the potential for ammonia generation by core-shell reforming catalyst 10. Alternatively, for a fuel cell that can tolerate some amount of ammonia, rhodium shell 14 need only cover a smaller portion of the surface of metal core 12—between about 10% and about 80%. While the ammonia forming potential of core-shell reforming catalyst 10 is not reduced as much with a submonolayer as it is with a monolayer or multilayer, the overall cost of core-shell reforming catalyst 10 can be significantly lower since less rhodium is required for a submonolayer rhodium shell 14. Thus, depending on the fuel cell using the hydrogen generated by core-shell reforming catalyst 10, rhodium shell 14 can cover between about 10% and about 100% of the surface of metal core 12.

FIG. 2 illustrates a simplified schematic of a natural gas reformer. Natural gas reformer 16 includes hydrocarbon inlet 18, steam inlet 20, core-shell reforming catalyst 10, hydrogen reformate outlet 22 and byproduct outlet 24. Natural gas reformer 16 also includes a system for heating natural gas reformer 16 (not shown in FIG. 2). Natural gas (or other hydrocarbon) enters natural gas reformer 16 through hydrocarbon inlet 18 while steam enters natural gas reformer 16 through steam inlet 20. Hydrogen is produced at an elevated temperature in the presence of core-shell reforming catalyst 10 within natural gas reformer 16 according to Reaction 1 shown above. The generated hydrogen is removed from natural gas reformer 16 through hydrogen reformate outlet 22 and is suitable for use as fuel for a fuel cell. In exemplary embodiments, hydrogen exiting natural gas reformer 16 through hydrogen reformate outlet 22 has an ammonia concentration of 15-20 ppm with 1% N₂ in the natural gas. The carbon monoxide generated by Reaction 1 and any other compounds formed in natural gas reformer 16 are removed from natural gas reformer 16 through byproduct outlet 24. The carbon monoxide can be further reacted with water according to Reaction 2 to produce hydrogen and carbon dioxide.

FIG. 3 illustrates a method for preparing core-shell reforming catalyst 10. Method 26 includes adding a metal core to a reaction vessel (step 28), adding a rhodium compound to the reaction vessel (step 30) and depositing the rhodium compound on the metal core (step 32). In one embodiment of method 26, the rhodium compound is a rhodium salt and the metal core contains nickel. Suitable rhodium salts include rhodium acetate, rhodium chloride, rhodium nitride and combinations thereof. Nickel is a reactive metal and when it contacts the rhodium salt the nickel reduces the rhodium salt to form a layer of rhodium on the nickel. An aqueous solvent or solution can be employed during depositing step 32. Suitable aqueous solvents and solutions include water, aqueous acids such as 0.1 M HClO₄, organic solvents such as ethylene glycol and combinations thereof. An inert gas is typically employed during depositing step 32. The inert gas can be added to the reaction vessel in step 28, step 30 and/or step 32. Suitable inert gases include argon and nitrogen.

To summarize, a natural gas reforming core-shell catalyst that reduces the potential for ammonia formation includes a metal core and a rhodium layer surrounding the metal core. The rhodium layer prevents ammonia formation by providing a catalytic pathway for hydrogen generation that has a reduced potential for ammonia production.

Although the present invention has been described with reference to preferred embodiments, workers skilled in the art will recognize that changes may be made in form and detail without departing from the spirit and scope of the invention.

I claim:

1. A hydrocarbon reformer, comprising:
a vessel having at least one inlet and at least one outlet; and
a reforming catalyst in the vessel, the reforming catalyst comprising a metal core and a rhodium layer deposited on the metal core;
wherein a hydrocarbon introduced into the vessel through the at least one inlet reacts with an aqueous solvent in the presence of the reforming catalyst to produce hydrogen that is released through the at least one outlet.

2. The hydrocarbon reformer of claim 1, wherein the metal core comprises nickel.

3. The hydrocarbon reformer of claim 1, wherein the metal core comprises palladium.

4. The hydrocarbon reformer of claim 1, wherein the rhodium is alloyed with at least one metal selected from the group consisting of platinum, palladium and iridium.

5. The hydrocarbon reformer of claim 1, wherein the rhodium is deposited on the metal core as a monolayer covering substantially all of the metal core.

6. The hydrocarbon reformer of claim 5, wherein the rhodium monolayer has a thickness of about 0.25 nanometers.

7. The hydrocarbon reformer of claim 1, wherein the rhodium is deposited on the metal core as at least one submonolayer covering at least some of the metal core.

8. The hydrocarbon reformer of claim 7, wherein the metal core has a surface, and wherein the rhodium covers between about 10% and about 80% of the surface of the metal core.

9. The hydrocarbon reformer of claim 8, wherein the rhodium covers between about 10% and about 100% of the surface of the metal core.

10. The hydrocarbon reformer of claim 1, wherein multiple layers of rhodium are deposited on the metal core.

11. The hydrocarbon reformer of claim 10, wherein the multiple layers of rhodium have a combined thickness between about 0.5 nanometers and about 3 nanometers.

12. The hydrocarbon reformer of claim 1, wherein the hydrocarbon comprises natural gas.

13. The hydrocarbon reformer of claim 1, wherein the hydrocarbon comprises methane.

14. The hydrocarbon reformer of claim 1, wherein the hydrogen released through the at least one outlet contains no more than 20 ppm ammonia.

15. The hydrocarbon reformer of claim 1, wherein
the at least one inlet comprises a first inlet for introducing the hydrocarbon into the vessel and a second inlet for introducing the aqueous solvent into the vessel; and
the at least one outlet comprises a first outlet for releasing the hydrogen from the vessel and a second outlet for releasing at least one byproduct from the vessel.

16. The hydrocarbon reformer of claim 1, wherein
the metal core comprises nickel; and
the rhodium layer is a result of a rhodium salt reduced by the nickel.

17. The hydrocarbon reformer of claim 16, wherein the rhodium salt comprises at least one of rhodium acetate, rhodium chloride, and rhodium nitride.

18. The hydrocarbon reformer of claim 1, wherein the aqueous solvent comprises at least one of water, an aqueous acid, and an organic solvent.

19. A method of producing hydrogen comprises:
introducing a hydrocarbon into a reformer; and
reacting the hydrocarbon with an aqueous solvent in the presence of a reforming catalyst in the reformer, the reforming catalyst including a metal core and a rhodium layer deposited on the metal core.

20. The method of claim 19, wherein
the hydrocarbon comprises at least one of natural gas and methane;
the aqueous solvent comprises at least one of water, an aqueous acid, and an organic solvent;
the metal core comprises nickel; and
the rhodium layer is a result of a rhodium salt reduced by the nickel.
